(19) United States
(12) Patent Application Publication
(10) Pub. No.: US 2006/0287983 A1
(43) Pub. Date: Dec. 21, 2006

(54) Avoiding slow sections in an information search

(75) Inventors: Jeffrey Krauss, Woodinville, WA (US); Olga Veselova, Sammamish, WA (US); Christopher Pratley, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/154,118

(22) Filed: Jun. 16, 2005

(51) Int. Cl. G06F 17/30

(52) U.S. Cl. 707/3

(57) ABSTRACT

Avoiding slow searches of stored information is described. During a search for notes or other information responsive to a search request, notes or other information that contain a search string, but that are located at remote memory locations may be skipped from retrieval for a requesting user due to an excessive amount of time required for retrieving the notes or information from the remote memory locations. If notes or information stored at remote memory locations are part of a personal “notebook” of notes or information of the requesting user, the notes or information stored at the remote memory locations may be retrieved regardless of the associated retrieval time.

### BACKGROUND

With the advent of the computer age, computer and software users have grown accustomed to user-friendly software applications that help them write, calculate, organize, prepare presentations, send and receive electronic mail, make music, and the like. For example, modem electronic word processing applications allow users to prepare a variety of useful documents. Modem spreadsheet applications allow users to enter, manipulate, and organize data. Modem electronic slide presentation applications allow users to create a variety of slide presentations containing text, pictures, data or other useful objects. Modem database applications allow users to store, organize and exchange large amounts of data. Modem electronic notes applications allow users to store, sort, review and utilize typed and handwritten notes.

With word processing applications and notes applications, users often store a variety of information in a manner previously performed with paper and pen. For example, a user may type or electronically handwrite notes into a word processing file or notes application file. A user may enter notes and other information about a variety of topics, for example, a school lecture or office meeting. Entered notes and other information may be stored locally on the user's local computer, or notes and information may be stored remotely via a distributed computing network. Once a user has entered and stored notes or other information, retrieval of the information on a given topic becomes important. For example, a user may desire to retrieve all notes previously entered concerning a particular business meeting.

Methods have been developed for indexing information, such as notes or other information, so that a subsequent search for a given piece of information may locate the requested information, for example, by page location. Once a desired piece of information is located, the page containing the information may be displayed to a requesting user via a graphical user interface. However, if the requested information is located on a remote source, for example, on a remote server accessible via a distributed computing network, a significant amount of time may be required to locate and retrieve the requested information for presentation to the user. For example, a retrieval of remotely stored information may take two minutes as opposed to ten seconds for locally stored information. Slow search and retrieval of desired information can make for a very unsatisfying user experience. And, if the user's software application, for example, a notes application or word processing application cannot connect to the remote source at the time of the information search, the user's search may not net expected results.

Often requested information may not have been indexed at the time of an associated search request. If information that has not been indexed is requested via a search request, the requested information must be located by a scan of available storage areas, for example, storage folders, in which the requested information may be stored. If the non-indexed information is stored remotely, an excessive amount of time may be required for retrieving the remotely stored information, as described above.

In addition, if a user launches a notes application at a page of information that is located at a remote source, the aforementioned issues regarding retrieval of information from a remote storage location may cause a slow boot up of the launched application while the remotely stored information is retrieved.

It is with respect to these and other considerations that the present invention has been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

In accordance with embodiments of the present invention, methods, systems, and computer products are provided for avoiding slow searches of stored information. According to one aspect of the invention, when a search request is received for stored information, such as typed or handwritten notes, an index of previously stored information is parsed for information matching the received search request. If matching information is from a source from which information may be retrieved without undue delay, for example, a storage folder on a local computer, the requested information is retrieved for presentation to the requesting user. If the requested and indexed information is on a remote source from which retrieval of the requested information will take a significant amount of time, the requested information may be skipped during the search. Alternatively, if the requested information is remotely stored, but is part of the requesting user's personal “notebook” of information, the requested information may be retrieved.

According to another aspect, if requested information is not indexed and the requested information is stored as part of the requesting user's personal “notebook” of information whether locally or remotely, the requested information is retrieved for presentation to the user. However, if the non-indexed requested information is stored outside the user's personal “notebook” of information, and the requested information is stored remotely, then the requested information may be skipped during the search.

At the conclusion of the search, retrieved information responsive to the requested search is presented to the requesting user. Additionally, a summary of skipped information is provided to the requesting user to inform the user that some information responsive to the request was not retrieved in order to enhance information retrieval performance. According to an alternative aspect, the requesting user may initiate a retrieval of the skipped information, if desired, with the understanding that the retrieval of the requested information may take a longer than expected time.

These and other features and advantages, which characterize the present invention, will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram illustrating an exemplary computing operating environment for implementing various embodiments of the present invention.

FIG. 2 illustrates a computer screen display of a notes application user interface for entering and displaying typed or handwritten notes.

FIG. 3 illustrates a computer screen display of an example notes application user interface showing retrieved information and showing information regarding skipped information during an information retrieval search.

FIG. 4 is a simplified block diagram illustrating a relationship between a notes application information search and an index of previously entered information.

FIG. 5 is a logical flow diagram illustrating a routine for avoiding a slow search and retrieval of requested information.

### DETAILED DESCRIPTION

As briefly described above, embodiments of the present invention are directed to methods, systems, and computer products for avoiding slow search and retrieval of stored information, such as notes and other information entered via a notes application or word processing application. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

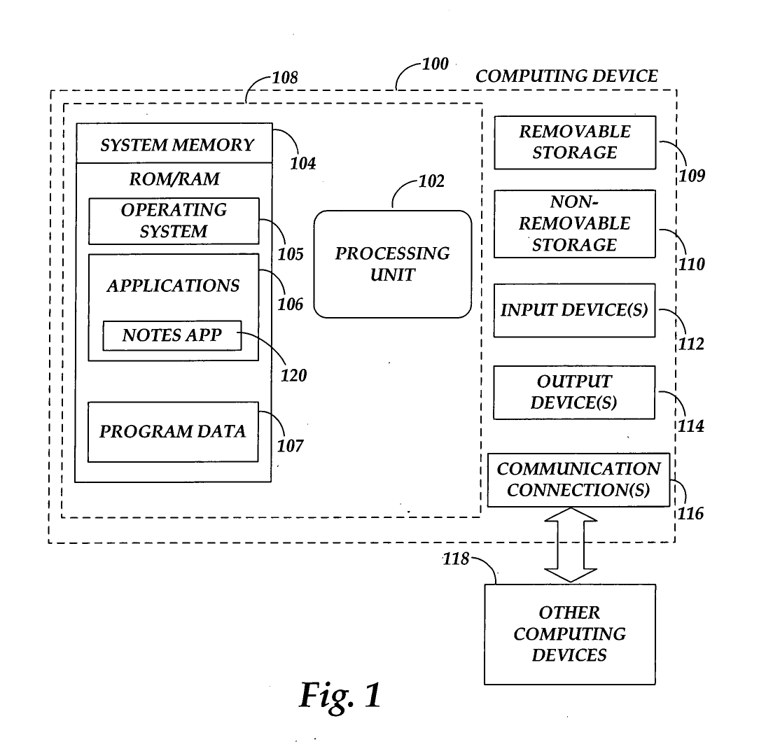

Referring now to the drawings, in which like numerals refer to like elements through the several figures, aspects of the present invention and an exemplary computing operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the invention may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one exemplary system for implementing the invention includes a computing device, such as computing device 100. In a basic configuration, the computing device 100 typically includes at least one processing unit 102 and system memory 104. Depending on the exact configuration and type of computing device, the system memory 104 may be volatile (such as RAM), non-volatile (such as ROM, flash memory, etc.) or some combination of the two. System memory 104 typically includes an operating system 105 suitable for controlling the operation of a networked personal computer, such as the WINDOWS® operating systems from MICROSOFT CORPORATION of Redmond, Wash. The system memory 104 may also include one or more software applications 106, 120 and may include program data 107. This basic configuration is illustrated in FIG. 1 by those components within dashed line 108.

According to embodiments of the invention, the application 106 may comprise many types of programs, such as an electronic mail program, a calendaring program, an Internet browsing program, and the like. An example of such programs is OUTLOOK® manufactured by MICROSOFT CORPORATION. The application 106 may also comprise a multiple-functionality software application for providing many other types of functionalities. Such a multiple-functionality application may include a number of program modules, such as a word processing program, a spreadsheet program, a slide presentation program, a database program, and the like. An example of such a multiple-functionality application is OFFICE™ manufactured by MICROSOFT CORPORATION. A notes application 120 is illustrated for entering, storing and retrieving typed or handwritten notes or other information in accordance with embodiments of the present invention. An example notes application 120 includes ONENOTE® manufactured by MICROSOFT CORPORATION.

The computing device 100 may have additional features or functionality. For example, the computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well known in the art and need not be discussed at length here.

The computing device 100 may also contain communication connections 116 that allow the device to communicate with other computing devices 118, such as over a network in a distributed computing environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

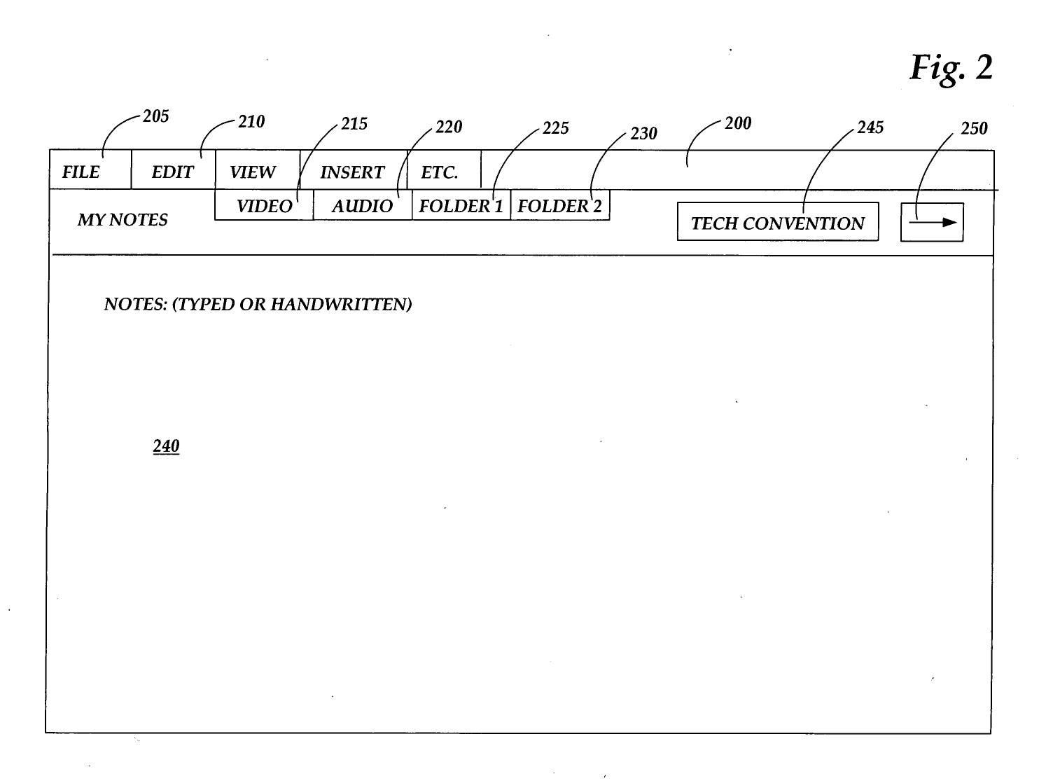

Referring now to FIG. 2, a user interface 200 of a notes application 120 is provided. According to embodiments, the notes application 120 allows for the entry, storage and retrieval of typed and handwritten notes and other data. An exemplary notes application 120 is ONENOTE® manufactured by MICROSOFT CORPORATION. It will be appreciated, however, that embodiments of the present invention are equally applicable to any suitable application useful for entering, storing and retrieving typed or handwritten data, for example, word processing applications. Referring still to FIG. 2, the user interface 200 of the example notes application 120 includes high level commands, such as the file command 205, the edit command 210, the view command, the insert command, and the like, for storing, formatting, and otherwise manipulating text or data entered and stored via the user interface 200.

A number of information storage tabs 215, 220, 225, and 230 are illustrated for allowing a user to access and supplement stored information. For example, the video tab 215 may allow a user to access video information entered and stored with the notes application 120. Likewise, the audio tab 220 may allow the user to access audio files stored using the notes application 120. The folder tabs 225, 230 may allow a user to access one or more folders of stored information. For example, the folder tab 225 may allow a user to access notes stored during a number of school lectures. The folder tab 230 may allow a user to access typed or handwritten notes entered in association with one or more business meetings. As should be appreciated, the illustrated information tabs 215, 220, 225, 230 are for purposes of example only and are not limiting or restrictive of the number of and different types of information storage locations that may be created by the user of the notes application 120.

According to embodiments of the present invention, a user may establish a storage of information as the user's personal “notebook” of notes and information. The user's “notebook” of notes and information may be stored entirely on the user's local computer 100. Alternatively, portions of the user's personal “notebook” of notes and information may be stored on the user's local computer, and other portions of the “notebook” may be stored remotely. Alternatively, all of the notes or information comprising the user's “notebook” may be stored remotely. As should be appreciated a tab 225, 230 may be established for the user's personal “notebook” of notes and information.

A data entry area 240 is provided into which a user may type or handwrite a variety of information regarding a variety of topics. For example, if the notes application 120 is functionally connected with a keyboard, a user may type notes or other information directly into the work area 240. On the other hand, if the notes application 120 is configured for operation with an electronic pen device, handwritten notes may be entered into the work area 240 according to well known electronic pen and ink systems. Once information is typed or handwritten into the work area 240, the information may be stored in a variety of storage locations for subsequent retrieval and/or editing.

According to embodiments of the present invention, a search pane 245 is provided in the user interface 200 for entry of a search string for requesting typed or handwritten notes or other information containing the entered search string. For example, referring still to FIG. 2, a search string of “tech convention” is illustrated in the search pane 245. After a requesting user enters the search string and selects the search activation button 250, one or more selected information storage locations is searched for typed or handwritten information containing the entered text string. For example, if a user desires to search the contents of a particular information storage folder for notes previously entered by the user relating to an upcoming tech convention, the user may first select the desired storage folder followed by entry of a desired text string in the search pane 245. After entry of the desired text string and initiation of the search, the selected folder is searched for typed or handwritten entries containing the entered text string.

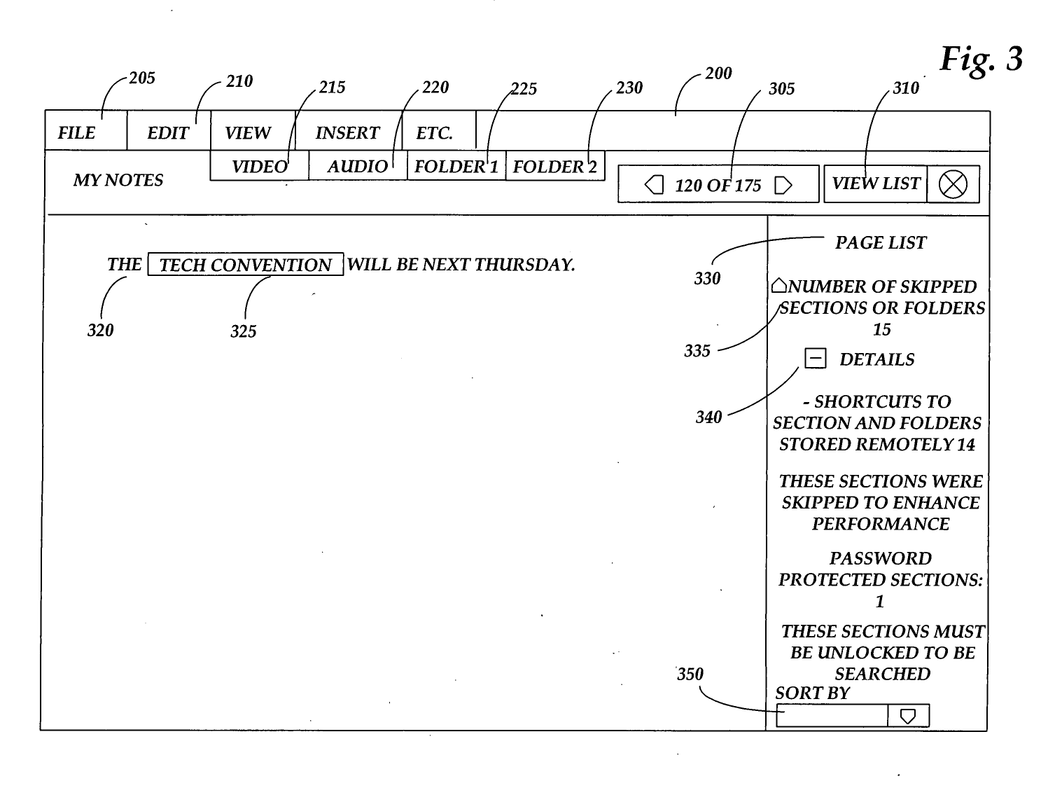

Referring now to FIG. 3, once the search of the selected storage location is complete, search results, for example, handwritten or typed notes are displayed in the work area 240. For example, as illustrated in FIG. 3, a note “The tech convention will be next Thursday” has been retrieved in response to the search request and has been displayed in the user interface work area. The search string “tech convention” is highlighted by a highlighter 325 to inform the user of the location of the search text string in the responsive note or other information retrieved and displayed.

Referring still to FIG. 3, the search pane 245 is replaced with a search result information pane 305 which shows the total number of pages, for example, 175 pages, retrieved as a result of the entered search text string. In addition, the presently displayed page is identified. For example, the illustrated search result of “120 of 175” illustrates that the displayed search result is on retrieved page 120 of a total of 175 retrieved pages. A pair of scroll controls is illustrated in the pane 305 for allowing a forward and backward scrolling through retrieved pages of information. A view list control 310 is illustrated for allowing a user to selectively view a list of retrieved information pages from which a user may select one or more desired pages.

As described in detail below, certain portions of notes or information responsive to a given search request may be stored at a remote storage location, and may take a considerable amount of time for retrieval by the notes application 120 in response to an entered search string. According to embodiments of the present invention, during a given information retrieval, certain information responsive to the entered search string may be skipped during the search. As illustrated in FIG. 3, a search information pane 330 is provided for providing helpful information regarding a search conducted by the requesting user. A first section 335 includes information for informing the user as to a number of searched sections or storage folders that were skipped during the search executed by the user.

Upon selection of a “Details” control 340, detailed information as to skipped search sections and folders may be provided to the user. A first example detail which states “shortcuts to sections and folders stored remotely: 14” informs the user that of an example 15 skipped sections, 14 skipped sections were associated with shortcuts to sections and folders stored at remote storage locations. An additional information string, for example, “these sections were skipped to enhance performance” provides a user information as to why these sections were skipped during a search. The pane 330 includes additional controls, such as the sort control 350, for allowing the user to sort information retrieved in response to the executed search based on a variety of sorting properties. As should be appreciated, the information illustrated in the pane 330 is for purposes of example only and is not restrictive of the different types of information that may be provided to a user regarding a search request initiated by the user.

As briefly described above, according to embodiments of the present invention, information responsive to the entered search request may be located in remote storage locations, such as remote servers operated in a distributed computing network, such as the Internet or an intranet. For example, a user may store certain entered notes or other information on a remote storage server for subsequent access by the user, or for access by other users working with the user in a shared collaborative environment. In order to access such remotely stored information via a distributed computing network, the user's notes application 120 must be in contact with the remote storage location during retrieval of information responsive to the search request.

If the user's data connection with the remote storage location is slow, or if the user's connection experiences intermittent connectivity outages, retrieval of information stored at the remote storage location may be very slow. For example, retrieval of information from the remote storage location may take a considerable amount of time, for example, 2 minutes, as opposed to a relatively short amount of time for retrieval of information stored on the user's local computer 100, for example, 10 seconds. Moreover, if the user's data connection to the remote storage location has been lost during the search process, the user may wait a considerable amount of time for search results only to find that the data connection has been lost and that information responsive to the user's search will not be retrieved.

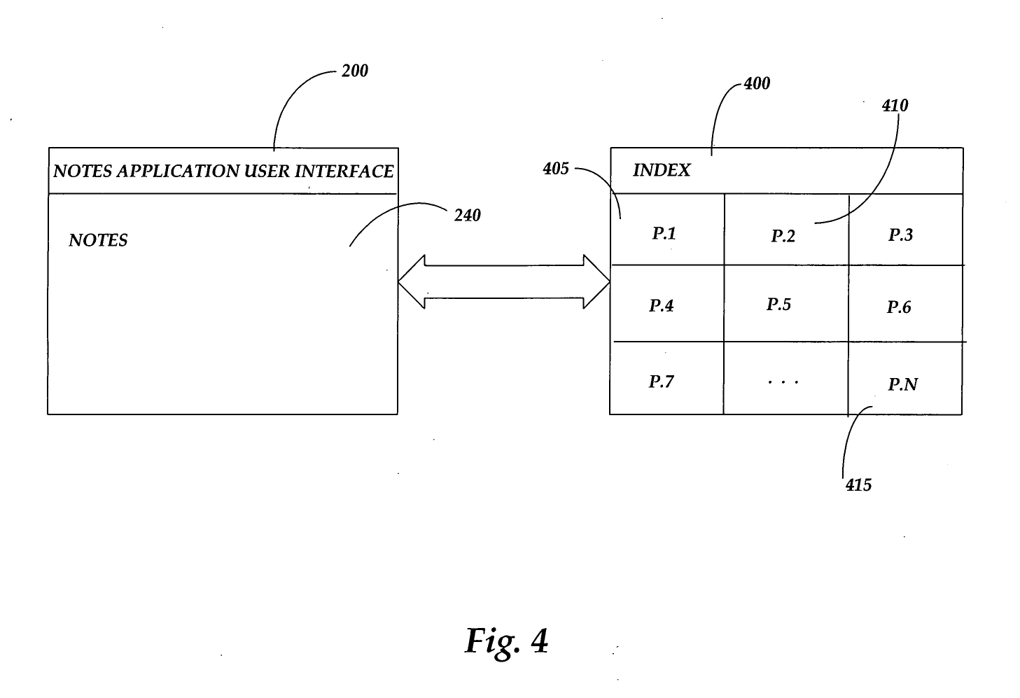

In order to enhance information search performance, methods have been employed for indexing information as it is entered by a user. Referring to FIG. 4, as information is entered into the user interface 200, the information may be indexed in an index 400 to allow for efficient location of the information during a subsequent search. For example, referring to FIG. 4, as notes or other information are entered into the user interface 200, data representing the information is stored in the index 400 relative to the pages in an associated “notebook” of notes or other information into which the user is storing the entered notes or information. For example, notes or other information entered into page 1 of the user's “notebook” are referenced in the page 1 section of the index 400. Notes or other information entered in the second page of the user's “notebook” are indexed in the page 2 section of the index 400, and so.

As should be appreciated, the index 400 may be modeled according to different indexing schemes. For example, information contained in an audio file may be indexed according to elapsed time segments. Information contained in a video file may be indexed according to video frame segments. According to embodiments of the present invention, once entered notes or other information are indexed in an index 400, subsequent location of information responsive to a given search request may be performed by parsing the index 400 and by returning specific pages containing information responsive to the entered search request. For example, referring back to FIG. 2, if the search string “tech convention” is entered, the pages in the index 400 containing information containing the entered text string “tech convention” may be returned in response to the entered search request. However, as described above, if one or more pages of indexed information are stored at a remote storage site, retrieval of the actual information, for example, notes or other data containing the entered search string, may be time consuming based on the required retrieval of the information from the remote storage location.

According to one embodiment, as information is entered and subsequently indexed, a copy of the information, for example, a copy of a page of entered notes may be stored on the user's local computer 100 as the same information is stored at a remote storage location. Accordingly, during a subsequent retrieval of the stored information, if the stored information is not available from the remote storage location, or if the information retrieval from the remote storage location is skipped due to performance issues, the copy of the information may be retrieved from the local computer 100 and may be presented to the user in response to the search request. As should be understood, however, if the information stored remotely is accessible to and editable by other users, for example, in a collaborative work environment, the information retrieved from the local computer 100 may not reflect changes in the information that have been made to the information at the remote storage location.

As briefly described above, under certain circumstances, information entered by a user may not be indexed at the time of a given search request. For example, according to a given notes application 120 or other software application in use by the user, entered notes or other information may be indexed at periodic times, for example, every two minutes, or information may be indexed during an idle time (e.g., temporary cessation of keyboard or mouse activity) during which the user does not interact with the notes application 120. As a result, when a search is received by the notes application 120, in addition to parsing an associated index 400 for information responsive to the search request, any information stored to a given storage location that has not been indexed must be scanned by the notes application 120 for information responsive to the received search request. Information stored on the user's local computer 100 may be retrieved relatively quickly, but as described above, information stored at a remote storage location may require an excessive amount of time for retrieval depending on the connectivity between the notes application 120 and the remote storage location and depending upon the rate of data retrieval from the remote storage location that is available to the notes application 120.

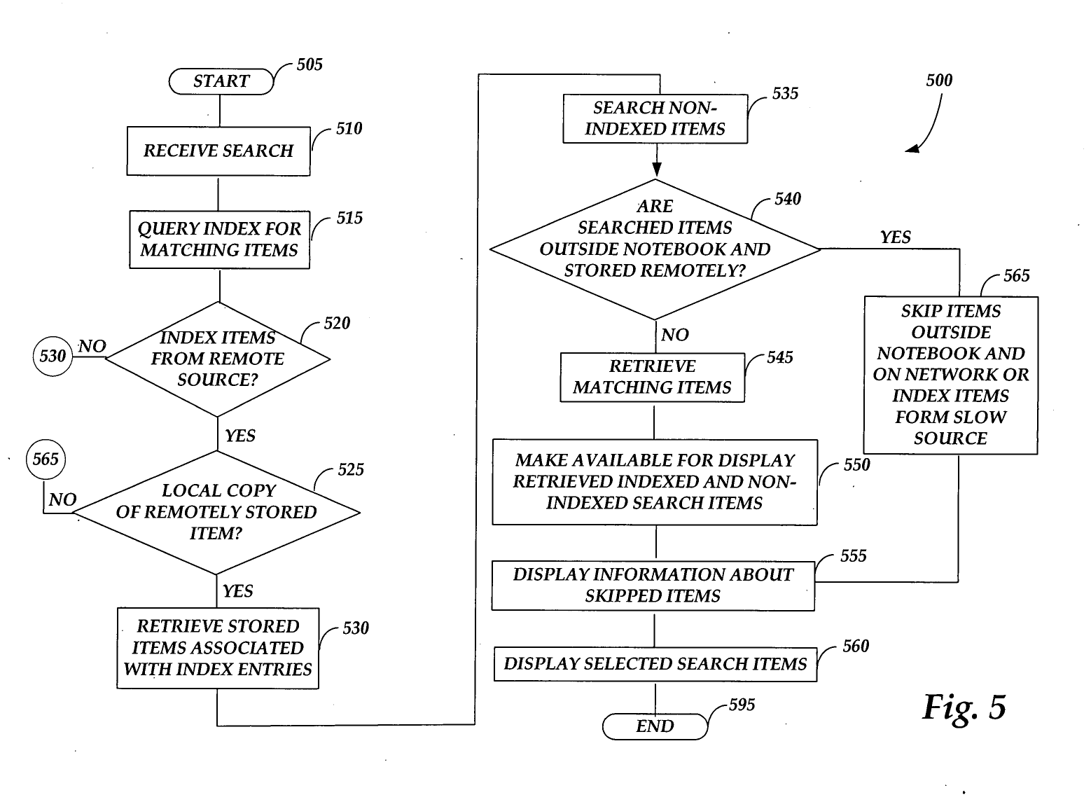

FIG. 5 is a logical flow diagram illustrating a routine for avoiding a slow search and retrieval of requested information. For purposes of example, operation of embodiments of the present invention will be described below with respect to an example notes or other information search request entered by a user, as illustrated in FIGS. 2 and 3 above. Referring then to FIG. 5, the routine 500 begins at start block 505 and proceeds to block 510 where a search request is received by the notes application 120. For example, the search string “tech convention” is entered by a requesting user as illustrated in FIG. 2.

At block 515, in response to the entered and executed search request, the notes application 120 parses the index 400 for matching items. That is, the notes application 120 parses the indexed pages of the index 400 for notes or other information containing the entered search string “tech convention.” At block 520, a determination is made as to whether any information located in the index 400 responsive to the entered search string is stored at a remote storage location accessible via a distributed computing network, such as the Internet or an intranet. If no items located in the index 400 are stored at a remote storage location, the routine proceeds to block 530, as described below.

If any items located in the index 400 are stored at a remote storage location, the routine proceeds to block 525, and a determination is made as to whether copies of the remotely stored items have been stored locally on the requesting user's local computer 100. If a locally stored copy of indexed information responsive to the search is available, the locally stored copy may be retrieved as a substitute for correspondingly remotely stored information for enhancing search performance. If a locally stored copy of notes or other information is presented to the user as a substitute for correspondingly remotely stored notes or information, a notification may be provided in the pane 330 to let the user know that the locally stored copy of the requested information may not be up to date as compared to the correspondingly remotely stored information.

If no locally stored copy of indexed information responsive to the search is available, the routine proceeds to block 565, and the remotely stored items may be skipped from the search, as described below. According to an alternative embodiment, if the entered search request is directed to information contained in the requesting user's personal “notebook” of notes or other information, information contained in the requesting user's personal “notebook” of notes or other information responsive to the entered search request is retrieved regardless of whether the information is stored locally or remotely. As should be appreciated, blocks 515, 520, and 525 may be repeated in loop fashion for each page or other index component in which information responsive to the entered search string is located.

At block 530, information located by parsing the index 400 responsive to the entered search string, whether stored locally, whether stored locally as a copy of otherwise remotely stored information, or whether stored locally or remotely as part of the user's personal “notebook,” is retrieved for subsequent presentation to the user in response to the entered search request.

At block 535, any notes or other information entered by the user that have not been indexed are scanned by the notes application 120 for individual notes or other items responsive to the entered search string. At block 540, the notes application 120 makes a determination as to whether any of the scanned items are outside the requesting user's personal “notebook” and are stored remotely.

If any scanned items are stored remotely and are not contained in the user's personal “notebook” of notes or other information, the routine proceeds to block 565, and any scanned information that is stored remotely and that is not on the user's personal “notebook” is skipped during the search. Additionally, any items not retrieved after parsing the index 400, described above with respect to blocks 515, 520, 525, 530, are also skipped during the search process. The routine then proceeds to block 555, as described below.

Returning back to block 540, if any of the non-indexed items scanned by the notes application 120 are not stored remotely, the routine proceeds to block 545, and any matching items are retrieved. At block 550, retrieved indexed item search results (block 530) and retrieved non-indexed search results (block 545) are assembled and made available for display to the requesting user. At block 555, information regarding any skipped content is generated for population in the pane 330, illustrated in FIG. 3, to inform the requesting user as to the nature of any items skipped during the search request. At block 560, notes or other information retrieved during the search are displayed in the user interface 200, as illustrated in FIG. 3, for review by the requesting user. The routine ends at block 595.

As described above, information contained in a search location that is designated as a personal “notebook” of the requesting user is always retrieved in response to an entered search request regardless of whether the information is stored remotely or locally and regardless of the amount of time that is necessary for retrieving responsive information. Alternatively, to enhance search performance, any information stored remotely may be skipped during the search process even if the information is contained in the user's personal “notebook” of notes or other information.

According to another embodiment of the present invention, the notes application 120 may be programmed to open to a page of information which was last being entered or edited by a user of the notes application 120 when an immediate last session of use of the notes application 120 was ended. Thus, upon launching a new session of the notes application 120, the page containing the last entered notes or other information is automatically displayed so the user may continue where she left off during the notes taking or information entering process. However, if the page containing the last entered notes or other information was stored remotely at the end of the last session of the notes application 120, booting up or launching the notes application 120 and simultaneously displaying the last page of notes or other information may require a significant amount of time if additional time is required for retrieving the last page of notes or information from the remote storage location.

If a significant amount of time is required to launch or boot up the notes application 120, as described above, the user may be unsatisfied with the time required for launching the application, or the user may falsely determine that a malfunction or other problem has occurred during launch or boot up of the application. According to embodiments of the present invention, if the last page of notes or other information was stored remotely by the user, during a subsequent launch or boot up of the notes application 120, the notes application 120 may automatically display the last page of notes or other information entered by the user that was stored locally, or alternatively, the notes application 120 may automatically display a locally stored copy of the last page of notes or other information that was stored remotely.

As the application is launching and displaying the page of information, the notes application 120 may continue to access and retrieve the last page of notes and other information stored remotely so that the display may be subsequently updated after the remotely stored page is retrieved. Accordingly, the user does not experience a delay in launch or boot up of the notes application 120 which may confuse the user as to whether the application will successfully launch. As described above, if a locally stored copy of a remotely stored page of notes or other information is displayed to the user, a notification may be provided to the user in the pane 330 to inform the user that the displayed information may not be up to date relative to information stored at the remote storage location.

It will be apparent to those skilled in the art that various modifications or variations may be made in the present invention without departing from the scope or spirit of the invention. Other embodiments of the present invention will be apparent to those skilled in the art from consideration of the specification and practice of the invention disclosed herein.

1. A method for retrieving results of a search request, comprising:
receiving a search request for one or more data items associated with a search string;
searching an index for an identification of any of the one or more data items associated with the search string;
returning one or more data items identified in the index that are stored at a local memory location and skipping one or more data items identified in the index that are stored at a remote memory location;
scanning one or more memory locations for any of the one or more data items associated with the search string that are not identified in the index; and
returning any of the one or more data items associated with the search string that are not identified in the index that are stored at a local memory location and skipping any of the one or more data items associated with the search string that are not identified in the index that are stored at a remote memory location.

2. The method of claim 1, further comprising displaying any of the returned one or more data items identified in the index and any of the returned one or more data items associated with the search string that are not identified in the index in a computer-generated display.

3. The method of claim 2, further comprising displaying in the computer-generated display a notification that any skipped one or more data items are not returned responsive to the search request because the skipped one or more data items are located at a remote memory location.

4. The method of claim 3, whereby displaying in the computer-generated display a notification that any skipped one or more data items are not returned responsive to the search request because the skipped one or more data items are located at a remote memory location includes displaying a notification identifying a memory location containing any skipped one or more data items.

5. The method of claim 4, whereby displaying in the computer-generated display a notification that any skipped one or more data items are not returned responsive to the search request because the skipped one or more data items are located at a remote memory location includes displaying a notification identifying a number of data items skipped during a search initiated by the search request.

6. The method of claim 1, further comprising prior to returning any of one or more data items identified in the index that are stored at a remote memory location, determining whether a copy of any of the one or more data items identified in the index that are stored at a remote memory location is stored at a local memory location; and
if a copy of any of the one or more data items identified in the index that are stored at a remote memory location is stored at a local memory location, returning the copy of the any of the one or more data items for display in response to the search request.

7. The method of claim 6, further comprising establishing a personal notebook of a requesting user where one or more data items contained in the personal notebook of the requesting user are stored in a remote memory location.

8. The method of claim 7, prior to skipping any of one or more data items stored at a remote memory location, determining whether the remote memory location is associated with the personal notebook of the requesting user, and if the remote memory location is associated with the personal notebook of the requesting user, returning the any one or more data items stored at the remote storage location associated with the personal notebook of the requesting user.

9. The method of claim 1, whereby receiving a search request for one or more data items associated with a search string includes receiving a search request for one or more data items stored at one or more local memory locations and stored at one or more remote memory locations where retrieval of one or more data items from any of the one or more remote memory locations requires connectivity between a retrieval application and the one or more remote memory locations over a distributed computing network.

10. A method of managing boot up of a notes application, comprising:
receiving a selection for launching a notes application where launching the notes application includes displaying a page of notes being edited in a last session of the notes application;
prior to displaying the page of notes being edited in the last session of the notes application, determining whether the page of notes being edited in the last session of the notes application was stored to a remote storage location at an end of the last session of the notes application; and
if the page of notes being edited in the last session of the notes application was stored to a remote storage location at an end of the last session of the notes application, displaying a most recent page of notes that was stored in a local storage location in response to launching the notes application.

11. The method of claim 10, further comprising:
if the page of notes being edited in the last session of the notes application was stored to a remote storage location at an end of the last session of the notes application, determining whether a copy of the page of notes being edited in the last session of the notes application was stored at a local storage location; and
if a copy of the page of notes being edited in the last session of the notes application was stored at a local storage location, displaying the copy of the page of notes being edited in the last session of the notes application in response to launching the notes application.

12. The method of claim 11, whereby if any page of notes is displayed in response to launching the notes application other than the page of notes being edited in the last session of the notes application, providing a notification that the page of notes being edited in the last session of the notes application was not displayed in response to launching the notes application.

13. A computer readable medium containing computer executable instructions which when executed by a computer perform a method for retrieving results of a search request, comprising:
receiving a search request for one or more notes associated with a search string;
searching an index for an identification of any of the one or more notes associated with the search string;
returning one or more notes identified in the index that are stored at a local memory location and skipping one or more notes identified in the index that are stored at a remote memory location;
scanning one or more memory locations for any of the one or more notes associated with the search string that are not identified in the index; and
returning any of the one or more notes associated with the search string that are not identified in the index that are stored at a local memory location and skipping any of the one or more notes associated with the search string that are not identified in the index that are stored at a remote memory location.

14. The computer readable medium of claim 13, further comprising displaying any of the returned one or more notes identified in the index and any of the returned one or more notes associated with the search string that are not identified in the index in a computer-generated display.

15. The computer readable medium of claim 14, further comprising displaying in the computer-generated display a notification that any skipped one or more notes are not returned responsive to the search request because the skipped one or more notes are located at a remote memory location.

16. The computer readable medium of claim 15, whereby displaying in the computer-generated display a notification that any skipped one or more notes are not returned responsive to the search request because the skipped one or more notes are located at a remote memory location includes displaying a notification identifying a memory location containing any skipped one or more notes.

17. The computer readable medium of claim 16, whereby displaying in the computer-generated display a notification that any skipped one or more notes are not returned responsive to the search request because the skipped one or more notes are located at a remote memory location includes displaying a notification identifying a number of notes skipped during a search initiated by the search request.

18. The computer readable medium of claim 13, further comprising prior to returning any of one or more notes identified in the index that are stored at a remote memory location, determining whether a copy of any of the one or more notes identified in the index that are stored at a remote memory location is stored at a local memory location; and
if a copy of any of the one or more notes identified in the index that are stored at a remote memory location is stored at a local memory location, returning the copy of the any of the one or more notes for display in response to the search request.

19. The computer readable medium of claim 18, further comprising establishing a personal notebook of a requesting user where one or more notes contained in the personal notebook of the requesting user are stored in a remote memory location.

20. The computer readable medium of claim 19, prior to skipping any of one or more notes stored at a remote memory location, determining whether the remote memory location is associated with the personal notebook of the requesting user, and if the remote memory location is associated with the personal notebook of the requesting user, returning the any one or more notes stored at the remote storage location associated with the personal notebook of the requesting user.
